(19) United States
(12) Patent Application Publication
(10) Pub. No.: US 2004/0022617 A1
(43) Pub. Date: Feb. 5, 2004

(54) Vehicle-mounted multiple stack loading and unloading system

(76) Inventors: Harrison A. Gardner, Cremona (CA); Mark H. Gardner, Cremona (CA)

Correspondence Address: Sean W. Goodwin, Goodwin Berlin McKay, The Burns Building, Suite 360, 237 - 8th Avenue S.E., Calgary, AB, T2G 5C3, CA

(21) Appl. No.: 10/283,299

(22) Filed: Oct. 30, 2002

(30) Foreign Application Priority Data
Jul. 30, 2002 (CA) 2,396,512

(51) Int. Cl. B65G 57/00

(52) U.S. Cl. 414/789.7

(57) ABSTRACT

Multiple stacks can be quickly and efficiently loaded, transported and unloaded through a plurality of pivoting and sliding decks and stack retaining means mounted on a vehicle frame. In an apparatus aspect, the system comprises a frame, a pivotable rear deck, a slidable front deck movable along the frame and rear deck for co-rotation therewith, and stack retaining means. Preferably the stack retaining means include forks extending from the rear end of the decks and clamping means associated with the front end of the decks. In a method aspect multiple stacks are loaded by: moving the front deck over the rear deck, rotating both decks so that the front deck's forks are adjacent the ground; advancing the front deck forks under a stack; rotating the decks so that the front deck is parallel to the frame; moving the front deck to a front-most position; rotating the rear deck so that its forks are adjacent the ground; advancing the rear deck forks under another stack; and rotating the rear deck so that it is parallel to the frame.

### FIELD OF THE INVENTION

The present invention relates generally to a loading and unloading apparatus and method for loading multiple stacks onto a truck, a trailer or the like and for subsequent transport and unloading of the stacks.

### BACKGROUND OF THE INVENTION

In modern farming, hay and straw is often formed and tied into square or rectangular bales. These bales are typically arranged in stacks formed form a plurality of similarly shaped bales. The stacks are then placed on the field or in a storage yard to be retrieved as needed. Often there is a need to move many bales in multiple stacks from one location to another. Conventionally, stacked bales may be transported using bale wagons, stack retrievers or flat-decked vehicles.

Bale wagons are typically designed to load individual bales from the field where they have been deposited. For example, U.S. Pat. No. 6,048,160 to Reist et al. discloses a bale wagon which picks up and handles individual bales as it traverses a field. The bale wagon orients the bales into a block-shaped stack which, when completed, can be transported from the field and unloaded as one entity—maintaining a generally rectangular shape. The major disadvantage of bale wagons is that they are incapable of loading an entire stack. They are instead restricted to loading individual bales and assembling them into a stack. This is a serious disadvantage should one wish to move an entire stack to a subsequent location. Bale wagons typically are not suitable for long distance road travel.

Stack retrievers are capable of loading an entire stack, transporting it to a subsequent location, and then unloading it. For example, U.S. Pat. No. 4,619,570 to Siebenga discloses a device comprising a deck pivotally mounted to the frame of a truck and fork members mounted to the rear-end thereof. This device is capable of lifting an entire stack from the field or yard to lay it down on its deck prior to transport. Once arrived at its destination, this stack retriever uses the fork mechanism and pivoting deck in a reverse sequence to unload the stack and place it in the new location. One disadvantage of this type of device is that only one stack can be transported at a time. Another disadvantage of Siebenga's device is that the retriever arms, as illustrated in the preferred embodiment, engages the stack laterally which has a tendency to crush the bales. The crushing restricts the flow of air through those bales thereby adversely increasing their drying time and also limiting the number of times a stack can be moved.

A flat-decked vehicle, where the deck is sufficiently long to support multiple stacks, is able to transport more than one stack of bales at a time. However, such vehicles generally require a tractor or forklift to load and unload the bales on and off the deck. These vehicles require multiple workers and piecemeal loading, and are inefficient except perhaps over long distances.

U.S. Pat. No. 6,312,205 to Vandenberg address some of these loading and unloading inefficiencies associated with flat-decked vehicles. Vandenberg discloses a bale loading arm affixed to a flat-decked vehicle to load bales onto a main deck, conveyor means to move the bales along the length of the flat deck and a shorter pivot deck with retaining forks mounted to the rear portion of the vehicle to assist in unloading. Vandenberg also contemplates loading of staked bales using the rear pivot deck and retaining forks and then moving those bales anteriorly using the chain conveyor means.

However, since Vandenberg's device only contemplates the loading and moving of large rectangular bales, roughly 4 feet by 4 feet by 8 feet and weighing up to two thousand pounds each, it does not deal with the problems associated with the loading and moving of stacks composed of small bales. For instance, the chain conveyor means disclosed by Vandenberg are insufficient to move a stack of small bales from one end of the deck to the other; simply because those bales between the paired chain conveyors would not be moved and would remain in position.

Ideally a device to transport bales would be able to transport multiple stacks of bales at one time, would be capable of handling stacks of either small or large bales, and would load and unload the bales quickly and efficiently all without undue crushing of the bales.

### SUMMARY OF THE INVENTION

A plurality of decks and stack-retaining means, mounted on a vehicle frame so as to enable sliding and pivoting of the decks and the retaining means in a novel fashion, provide a solution to the problem of loading and unloading multiple stacks of bales quickly, efficiently and without undue crushing of the bales.

In a preferred apparatus aspect, the vehicle-mounted multiple stack loading and unloading system comprises a frame, a rear deck pivotally mounted to the rear end of the frame and rotatable between a substantially horizontal position and a substantially vertical position, and a front deck movable along the support frame between a front-most transport position and rear-most co-pivoting position.

The apparatus further comprises means for pivoting the rear deck, means for moving the front dec, and means associated with each deck for retaining a stack thereon. The decks and frame are of such dimensions such that when the front deck is in the rear-most position it overlies the rear deck for co-rotation therewith, so that a front stack can be loaded and unloaded thereon, and such that when the front deck is in the front-most position it overlies the support frame and the rear deck is rotatable alone so that a rear stack can be loaded and unloaded thereon.

In another aspect a method is provided for retrieving and transporting two stacks of bales using a transport vehicle having a frame supporting a front deck and a rear deck which are normally and substantially parallel to the frame in a shipping position. The rear deck is pivotally mounted for rotation about a rear end of the frame. The method comprises the steps of: moving the front deck along the frame from a front-most shipping position to a rear-most pivoting position overlying the rear deck for co-rotation therewith, the front deck and the rear deck each having forks extending substantially perpendicularly therefrom; rotating the rear deck and overlying front deck so that the front deck's forks are adjacent the ground in a loading position; advancing the front deck forks under a first stack; rotating the rear deck and overlying front deck so that the front deck and first stack are again substantially parallel to the frame; moving the front deck along the frame from the rear-most pivoting position to the front-most shipping position; rotating the rear deck so that the rear decks forks are adjacent the ground in a loading position; advancing the rear deck forks under a second stack and; rotating the rear deck so that the rear deck and second stack are again substantially parallel to the frame wherein two stacks are loaded on the vehicle.

### BRIEF DESCRIPTION OF THE DRAWINGS

FIGS. 1a-1d are side views of four preparatory steps for loading double stacks of bales onto an empty bale retriever accordingly one embodiment of the invention. More particularly FIGS. 1a-1d illustrate both front and rear decks in a horizontal shipping position, the rear deck forks pivoted clear and the front decks moving rearwardly, the rear deck positioned in preparation for co-rotation with the rear decks, and both decks co-rotating towards a loading position;

FIGS. 1e-1j are side views of loading steps for loading the first of double stacks of bales onto the empty bale retriever accordingly to FIG. 1d. More particularly FIGS. 1e-1j illustrate a front stack being loaded onto the front and rear decks, the front stack being clamped by the rear deck forks, the front and rear decks co-rotating to the horizontal, a hand-off from the rear deck forks to the front deck forks, typically simultaneous but illustrated sequentially for illustrative purposes, and movement of the front deck and front stack towards and at the shipping position respectively;

FIGS. 1k-1m are side views of loading steps for loading the second of double stacks of bales onto the bale retriever according to FIG. 1j. More particularly FIGS. 1k-1m illustrate a rear stack being loaded onto the rear deck, the rear stack being clamped by the rear deck forks, and the rear deck and rear stack co-rotated to the horizontal shipping position;

FIG. 2a is a perspective view of an embodiment of the retaining forks of both front and rear decks illustrating co-operation at ground level when both decks are titled to a vertical position;

FIGS. 2b and 2d are plan and cross-sectional end views respectively according to FIG. 2a illustrating tubular forks of the rear deck;

FIGS. 2c and 2e are plan and cross-sectional end views respectively according to FIG. 2a illustrating the tubular forks of the rear deck nested into channel forks of the front deck;

FIGS. 3a-3b are partial cross-sectional end views of one embodiment of mounting means for securely mounting a sliding deck over a support frame and over a front deck respectively;

FIG. 4 is a top view of the mounting means accordingly to FIGS. 3a-3b;

FIG. 5 is a cross-sectional end view of means for securely mounting a clamping mechanism to a support frame;

FIG. 6 is a perspective view of co-operating clamping mechanisms for the rear and front decks;

FIGS. 7a-7b are rear-end views of a rear deck clamping mechanism capable of adjusting widthwise so as to allow for the easy pass-through of a stack of imprecise dimensions and to constrict to meet highway regulations when in transport;

FIGS. 7c-7d are top-views clamping mechanisms shown in FIGS. 7a-7b respectively;

FIG. 8 is a side view schematic of one embodiment of a push-off device to assist in unloading a stack from forks; and

FIG. 9 is a perspective view of the push-off device embodiment of FIG. 8.

### DETAILED DESCRIPTION OF THE PREFERRED EMBODIMENTS

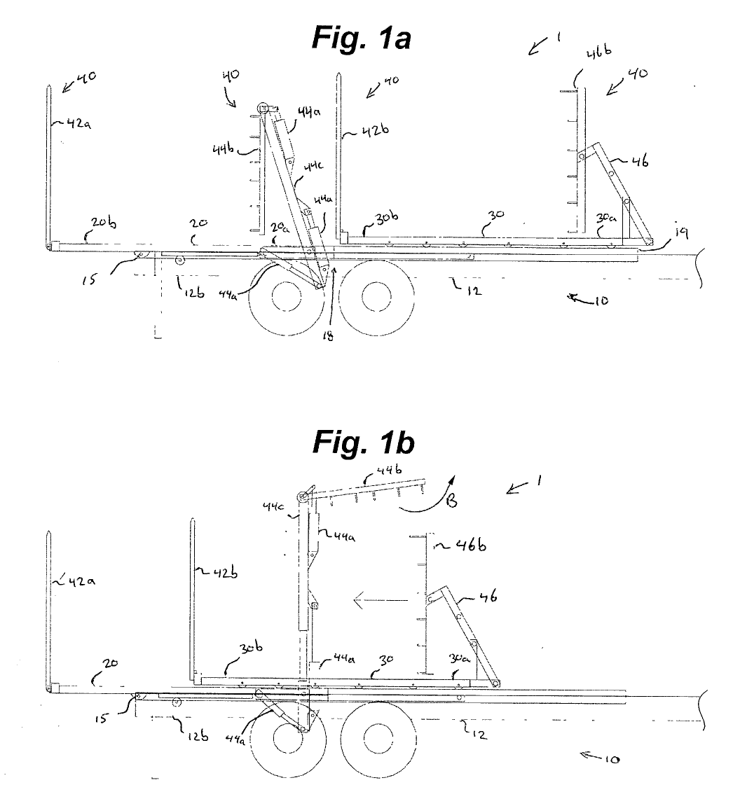

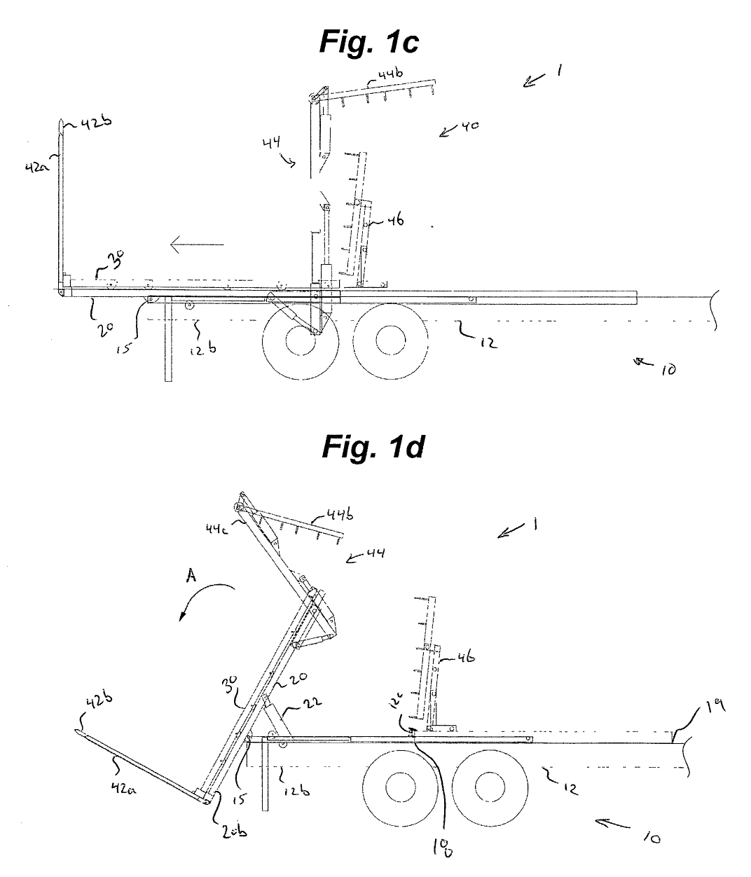

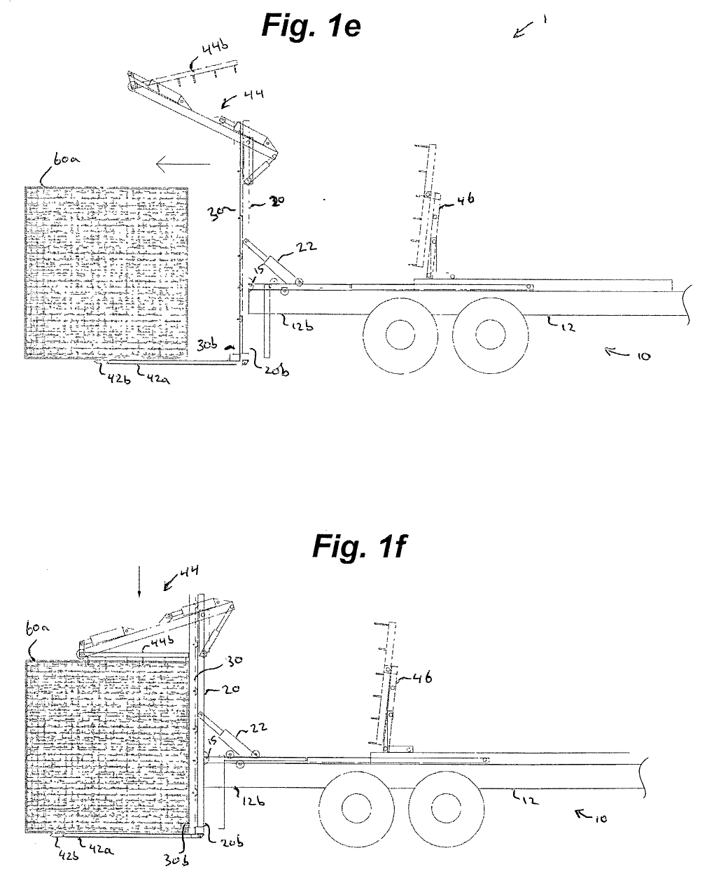

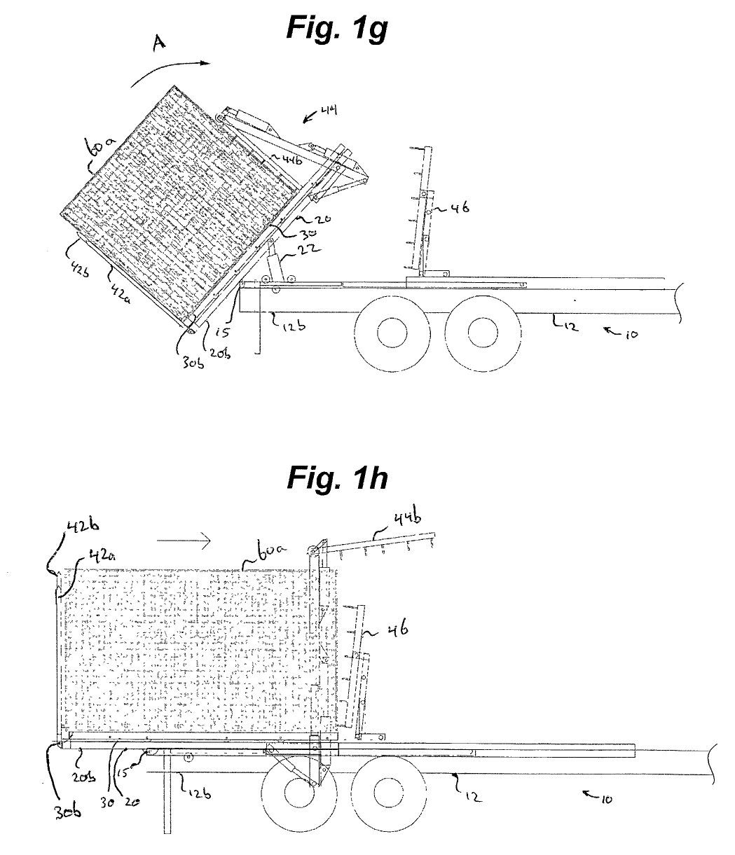

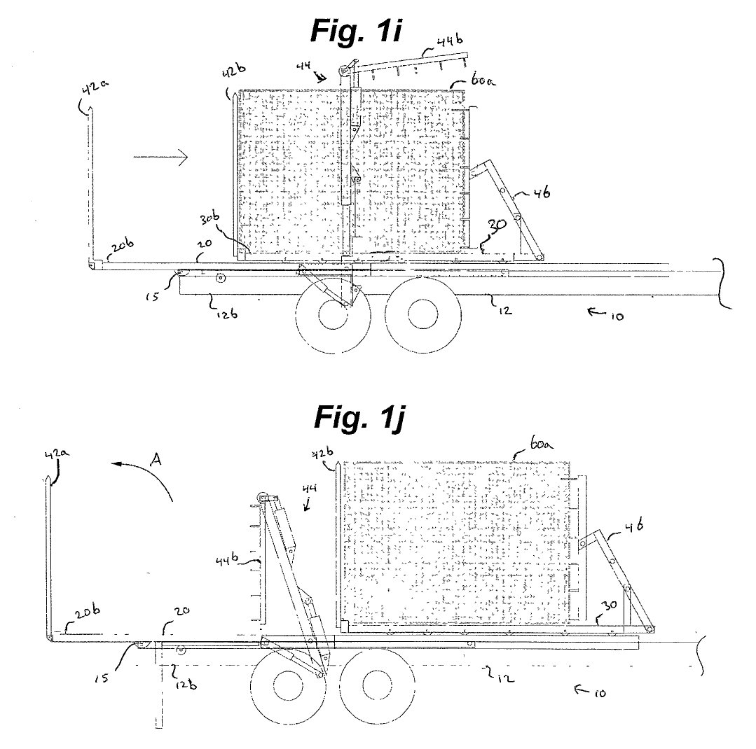

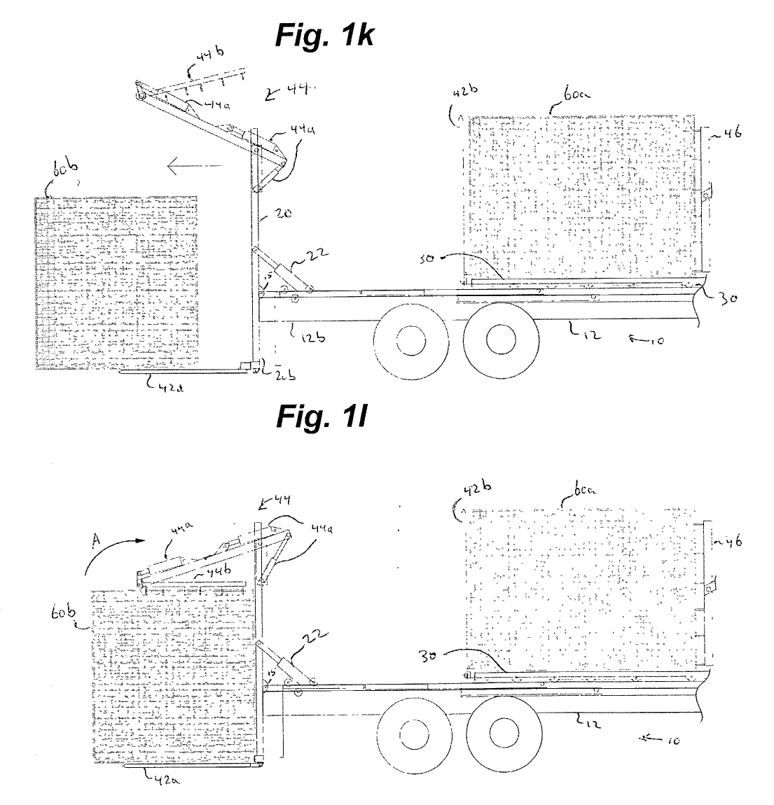

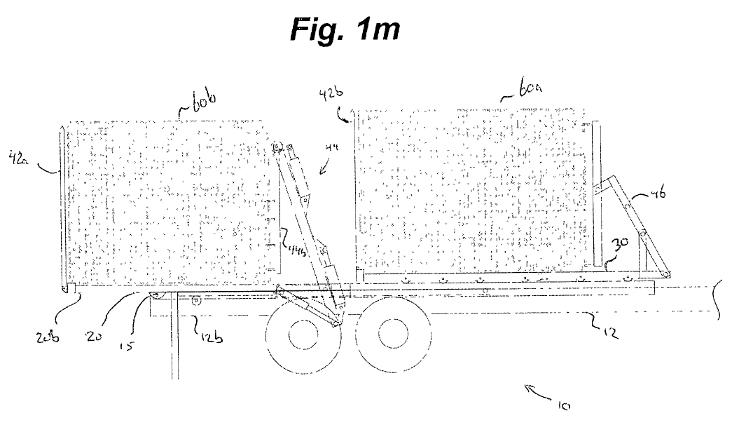

With reference to FIGS. 1a-1m, an embodiment of the invention is shown for a double stack retriever. A vehicle-mounted double stack loading and unloading system 1 is shown mounted to a support frame 12 of a transport vehicle 10. One example of a suitable transport vehicle 10 is a Freightliner model FLD 120 truck by Freightliner Ltd. of Mississauga, Ontario, although it will be understood that the vehicle 10 may be of any design or, in the alternative, may comprise a trailer having a wheel-supported frame.

In overview and with reference to FIG. 1a, an empty system, and FIG. 1m, a loaded system, the apparatus of the system comprises a pair of co-operating rear and front decks 20,30 each of which is capable of supporting a stack of bales 60a,60b respectively. Each stack 60a,60b can be securely clamped between forks 42a,42b and clamping mechanisms 44a,44b associated with each deck 20,30 respectively. As illustrated in FIGS. 1a-1m and as described in greater detail below, the rear deck 20 is configured for rotating in plane A from a transport or shipping position horizontal on the frame 12, to a ground-engaging or loading position wherein the forks 42a abut the ground for engaging the underside of a stack 60a or 60b (FIG. 1e). The front deck 30 is configured for alternate positioning either at the front of the support frame 12 in a shipping position, to a piggyback or overlying position over the rear deck 20 for co-rotation therewith to the loading position. The clamp mechanism 44b associated with the front deck 30 is configured for a handoff of its stack-supporting responsibility to the rear deck's clamping mechanism 44a which is capable of co-rotation with the rear deck 20.

More specifically, a first or rear deck 20 and a second or front deck 30 each have front 20a 30a and rear 20b, 30b ends respectively. The decks 20,30 are mounted to the frame 12 in a normally horizontal position for transport on the frame 12. The decks 20, 30 each are capable of supporting a stack 60a,60b. The decks 20, 30 are of sufficient size to each support their respective stack, preferably up to 160 small bales which, when stacked upright, typically have a dimension of 7 feet deep by 10 feet wide, by 13 feet 8 inches high. In a preferred embodiment, the decks 20, 30 are 15 feet long by 10 feet wide; so that a stack supported on its side on the deck would be 13 feet 8 inches long, 10 feet wide and 7 feet high. Decks 20, 30 of other sizes may be utilized depending on the dimensions of the stacks that are typically being loaded and unloaded.

The rear deck 20 is pivotally mounted at a rear end 12b of the frame 12 at pivot point 15 and its front end 20a partially extends anteriorly to terminate intermediate along the frame 12 at a point 18. The rear deck 20 is capable of rotating about pivot point 15 (FIG. 1d) to a loading position wherein the rear deck's rear end 20b substantially abuts the ground so that the deck 20 is oriented in a substantially vertical position and the forks 42a are substantially parallel with the ground. Actuating means 22 pivot the rear deck between a horizontal position (FIG. 1a) and substantially vertical, ground engaging, position (FIG. 1e). Preferably the actuating means 22 are hydraulic actuators or rams. Actuating means, such as hydraulic rams, for pivoting a deck about the rear end of a vehicle frame are well known to those of skill in the art and are not be reiterated herein.

The front deck 30 is slidably moveably mounted on top of both the frame 12 and rear deck 20 wherein it can slide between a front-most shipping position (FIG. 1a) and rear-most position (FIG. 1c). In the rear-most position, the front deck 30 overlays the rear deck 20 and is capable of co-rotation with the rear deck 20 (FIGS. 1c, 1d), in the front-most position, the rear deck 20 is unobstructed by the front deck 30 (FIGS. 1a, 1j).

The front deck 30 moves over the frame 12. Mounting means to securely mount a moveable deck 30 to a vehicle frame 12 while constraining unwanted movement are well known to those of skill in the art. Such mounting means can include rollers-in-guide, rollers on a rail with bracing means, and I-beams between opposing rails and resting on a slide or wear pad. Such means to slide a deck along a frame, including rollers, are well known to those of skill in the art.

When the front deck 30 is slidably moveably mounted on top of the rear deck 20, the rear deck 20 simply functions as a section of vehicle frame, and similar mounting means can be utilized as those to mount the front deck 30 to the frame 12. Preferably, to assist in the sliding of the front deck 30 over top of the rear deck 20, the frame 12 is higher from point 18 onward anteriorly to point 19 by an amount 12c approximately equal to the height or thickness of the rear deck 20 (FIG. 1d). It will be understood that the means to facilitate engaging and disengaging the front deck 30 over top of the rear deck 20 may be of any design, including an appropriate incline or ramp at about point 18.

Stack-retaining means 40 are provided to assist in loading and unloading a stack to and from the decks 20, 30. That portion of the stack-retaining means that engage the stack are well known to those of skill in the art. Some examples of stack-retaining means include incorporating a plurality of tine structures on opposing lateral edges of the deck, providing a set of forks perpendicularly secured to the rear end of a deck along with stabilizer arms, or providing paired clamping members opposing each other on the lateral sides of the deck.

In this embodiment the stack-retaining means 40 comprises two sets of co-operating retaining forks 42a 42b, each mounted substantially perpendicular to the rear end 20b, 30b of each of the first 20 and second 30 decks respectively. The forks 42a or sets of forks 42a, 42b are positionable at substantially ground level and in a generally horizontal orientation when the rear deck 20 or both decks 20, 30 are tilted in the general vertical position (FIGS. 1e, 1k) respectively. The sets of forks 42a, 42b co-operate so that both 42a, 42b are at substantially ground level and in a generally horizontal orientation when both decks 20, 30 are titled in the general vertical position (FIG. 1e).

In this embodiment, the stack-retaining means 40 further comprises a first clamping mechanism 44 and a second clamping mechanism 46. The first clamping mechanism 44 comprises a pivoting rack of tines 44b mounted between and at the distal ends of two lateral uprights 44c positioned on the left and right sides of the rear deck's 20 front end 20a and rotating means 44a to rotate the rack of tines 44b between a stack clamping and unclamped position. The rack of tines 44b is further are capable of pivoting in plane B so as to allow the retaining forks 42b of the front deck 30, and any stack placed thereupon, to pass underneath when the front deck 30 slides from the front-most to rear-most position (FIGS. 1b, 1h).

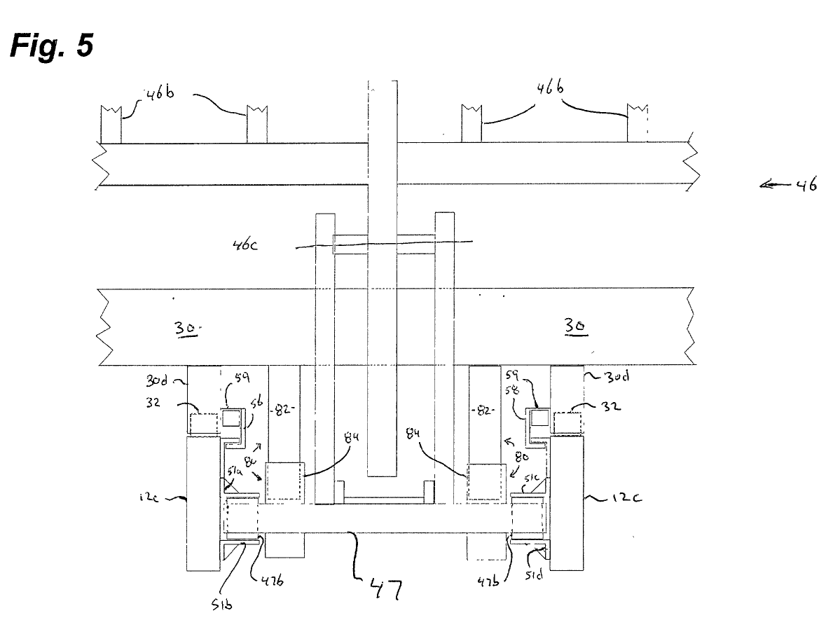

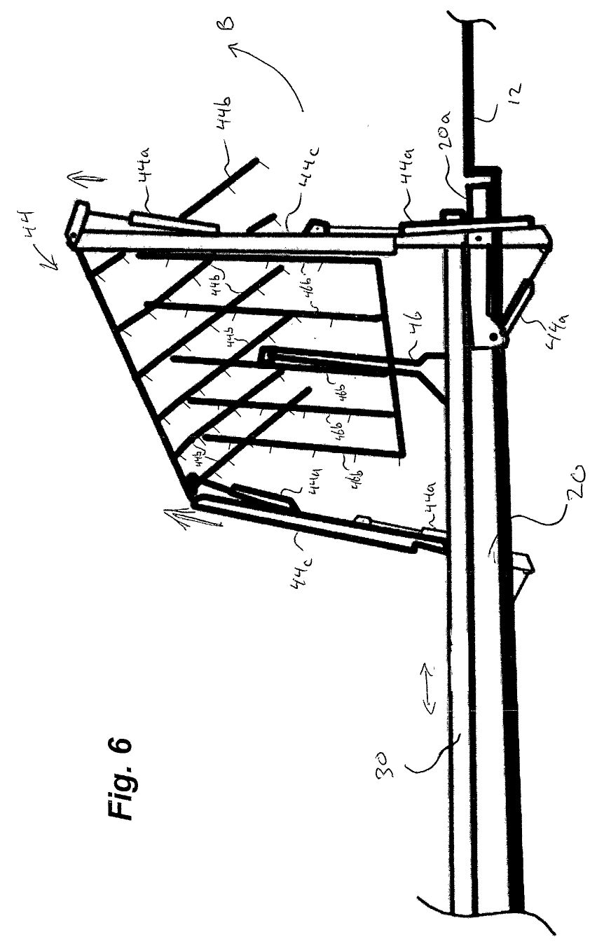

The second clamping mechanism 46 is slidably movably mounted on top of the support frame 12 at a position anterior to the front deck 30 and also features stack engaging rack of tines 46b. Mounting means to securely mount a clamping mechanism to a vehicle frame and prevent any unwanted movement are similar to those means to slidably mount a deck to a vehicle frame and are well known to those of skill in the art. Further, in this embodiment connecting means 80 (FIG. 5) enable the front deck 30 to connect to or detach from the clamping mechanism 46. Preferably, the sliding means to move the front deck 30 involve applying a sliding force through the clamping mechanism 46 to the front deck 30 while they are connected to each other.

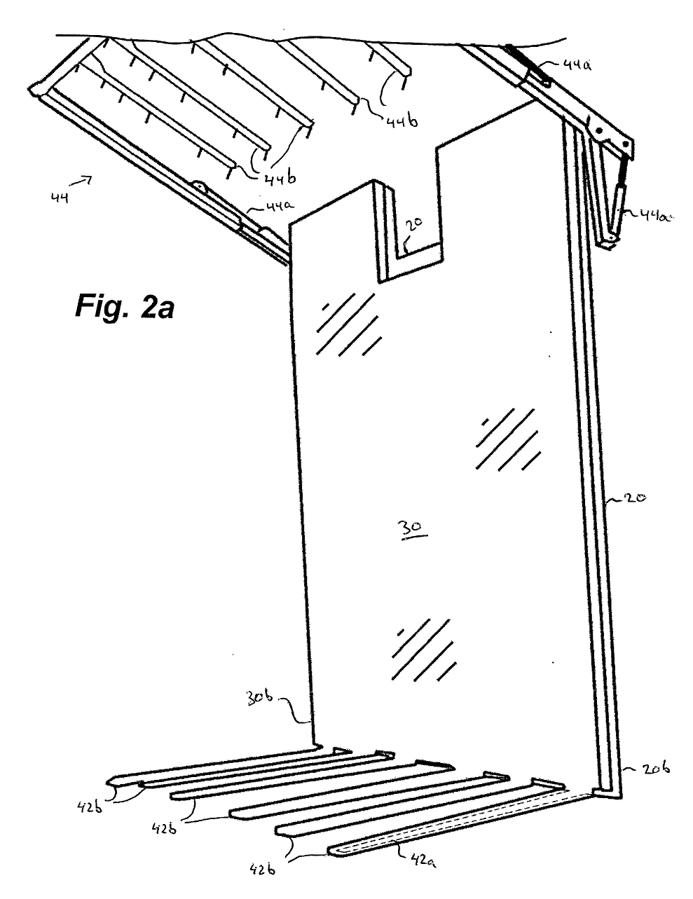

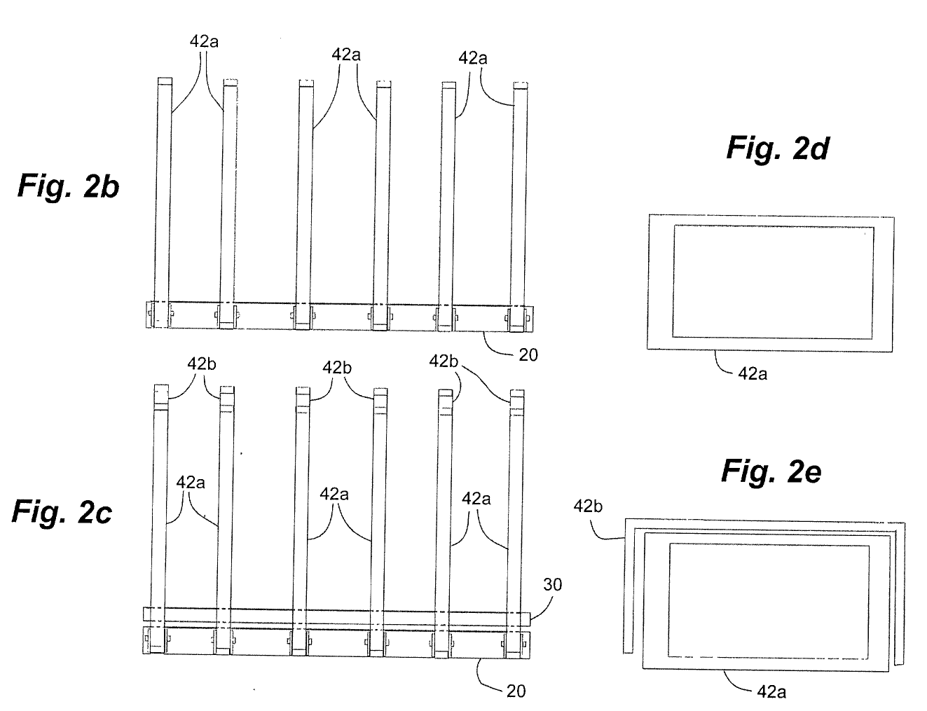

FIGS. 2a-e illustrate how the sets of forks 42a, 42b of the embodiment shown in FIGS. 1a-1m co-operate so that both 42a, 42b are at substantially ground level and in a generally horizontal orientation when both decks 20, 30 are tilted in the general vertical position. Each set of forks 42a, 42b has six individual forks. The front-deck forks 42b have a U-shaped cross-section, with the opening of the U facing towards the rear-deck forks 42a. The rear-deck forks 42a have a generally rectangular cross-section. The six individual forks of both sets 42a, 42b are positioned at identical intervals along the width of their respective decks 20, 30. The inside dimensions of the front-deck fork's 42b U-shape is slightly larger and deeper than the outside dimensions of the rear-deck forks 42a, so that when the front deck 30 is in the rear-most position, and both decks 20, 30 are titled in the general vertical position, the front-deck forks 42b neatly overlay the rear-deck forks 42a and both 42a, 42b are at substantially ground level.

Those skilled in the art will realize that there are other embodiments where both sets of forks are at substantially ground level when both decks are tilted in the general vertical position including, for example, placing the individual forks of each set at different positions across the width of their respective decks.

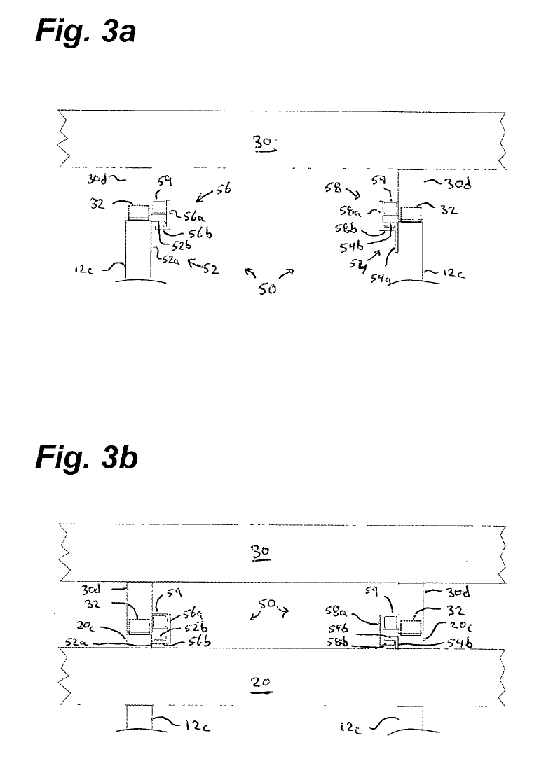

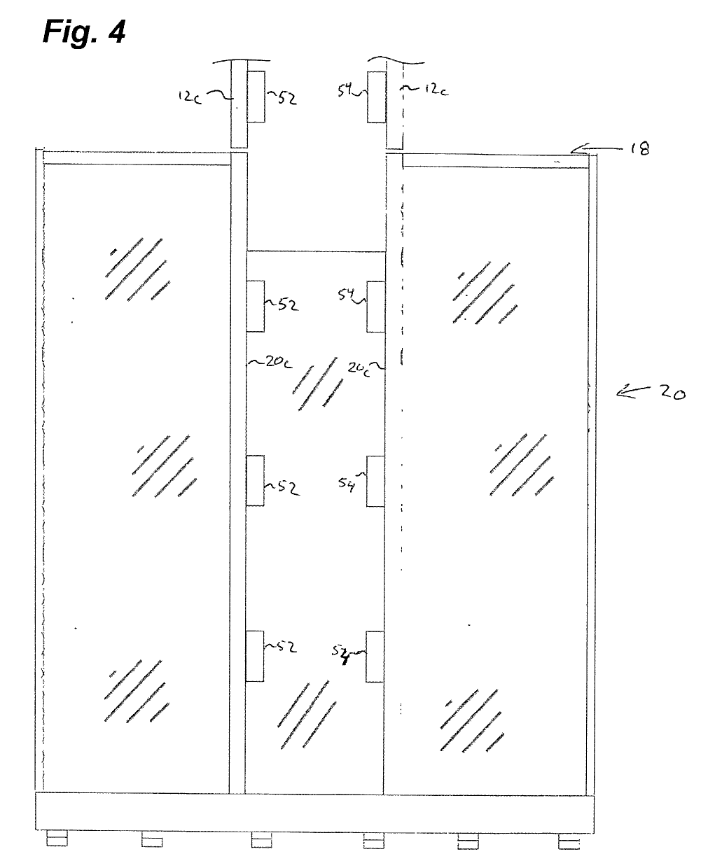

With reference to FIGS. 3a-b and 4, one embodiment of a mounting means 50, to securely mount a sliding deck 30 over a support frame 12 or a front deck 20, is illustrated. The support frame 12 includes a pair of oppositely spaced rails 12c mounted parallel to each other and to the longitudinal axis of the vehicle. Likewise, the front deck 20 includes a pair of oppositely spaced rails 20c mounted thereupon and oriented parallel to each other, the frame rails 12c and to the longitudinal axis of the vehicle. The individual rails of the paired frame rails 12c and deck rails 20c are spaced the same distance from each other, and substantially meet each other at point 18, thereby functioning as a single pair of rails along the longitudinal axis of the vehicle.

The sliding deck 30 includes paired longitudinal members 30d mounted to the underside thereof. The members 30d are profiled to house rollers 32 and are spaced so as to align over top of the oppositely spaced rails 12c, 20c of the frame 12 and deck 20 respectively. Rollers 32 are axled inside the side members 30d and run on top of the paired rails 12c. The rollers 32 allow for the deck 30 to slide upon the rails 12c, 20c, and are of such serviceability and robustness that the deck 30 remains freely slidable over a long service life.

To restrain movement of the sliding deck 30 along the longitudinal axis of the vehicle and keep the rollers 32 aligned over top of the oppositely spaced rails 12c, 20c, the mounting means 50 comprises several sets of paired L-shaped braces 52, 54 mounted along the inside length of the rails 12c, 20c. Each of the L-shaped braces 52, 54 have brace-engaging legs 52b, 54b and rail-engaging legs 52a, 54a. The braces 52, 54 and are mounted on the rails 12c, 20c such that the rail-engaging legs 52b, 54b are parallel to the inside wall of the rails 12c, 20c and the brace-engaging legs 52b, 54b extends inwardly towards the vehicle's longitudinal midline.

The mounting means 50 further comprises a pair of L-shaped braces 56, 58 mounted along the inside of the longitudinal members 30d of the sliding deck 30 by means of a spacer 59. The longitudinal length of the paired braces 56, 58 substantially extends the length of the deck 30. Like the braces 52, 54 on the rails 12c, 20c, the deck braces 56, 58 have member-engaging legs 56a, 58a and brace-engaging legs 56b, 58b. The braces 56, 58 and are preferably mounted on the deck's longitudinal members 30d by means of a spacer 59 and such that the member-engaging legs 56a, 58a are parallel to the wall of the member 30d and the brace-engaging legs 56b, 58b extends outwardly from the deck's 30 longitudinal midline.

The spacers 59 are of such dimensions, and the braces 56, 58 are mounted thereupon in such fashion, so that the brace-engaging legs 56b, 58b of the deck braces 56, 58 extend just underneath the brace-engaging legs 52b, 54b of the rail braces 52, 54 thereby keeping the deck firmly locked to the frame 12, or to the front deck 20 as the case may be, and preclude all other modes of relative movement other than sliding along the vehicle's longitudinal axis. The braces 52, 54, 56, 58, the rails 12c, 20c, the longitudinal members 30d and the spacers 59 are all preferably constructed of steel and fastened by welding.

FIG. 5 illustrates one embodiment of a mounting means 51 to slidably mount the second clamping mechanism 46 on of the support frame 12 at a position anterior to the front deck 30. In this embodiment, the second clamping mechanism 46 includes a base trolley 47 having rollers 47b and supporting the stack engaging rack of tines 46b pivotally mounted at point 46c. The support frame 12 includes a pair of oppositely spaced rails 12c mounted parallel to each other and to the longitudinal axis of the vehicle.

The mounting means 51 comprises several sets of paired L-shaped upper 51a and lower 51b braces mounted along the inside length of the rails 12c. Each of the L-shaped braces 51a, 51b has a rail-engaging leg 51d and a roller-engaging leg 51c. The braces 51a, 51b and are mounted on the rails 12c such that the rail-engaging legs 51d are parallel to the inside wall of the rails 12c and the roller-engaging legs 51c extend inwardly towards the vehicle's longitudinal midline.

In this embodiment, the width of the trolley 47 is just slightly less than the space between the two oppositely spaced rails 12c. The trolley's rollers 47b engage the roller-engaging legs 51c of the lower braces 51b. The upper braces 51a are mounted on the rails 12c so that their roller-engaging legs 51c are positioned just above the trolley's rollers 47b.

The rollers 47b allow for the clamping mechanism 46 to slide upon the frame rails 12c and are of such serviceability and robustness that the mechanism 46 remains freely slidable over a long service life. The upper braces 51a keep the rollers 47b aligned over top of the lower braces 51b. As the width of the trolley 47 is slightly less than the space between the two oppositely spaced rails 12c, the clamping mechanism 46 is restrained to moving only along the vehicle's longitudinal axis.

FIG. 5 also illustrates one embodiment of a connecting means 80 to enable the clamping mechanism 46 to connect or detach from the front deck 30. The connecting means 80 includes a pair of pins 82 mounted on the front deck 30 and a pair of sockets 84 mounted on the trolley 47 of the clamping mechanism 46. The pins 82 and sockets 84 are mounted so that the front deck 30 and clamping mechanism 46 are connected except when the front deck 30 is in the rear-most position when the pins 82 lift up and out of the sockets 84 as deck 30 is actuated to a vertical position.

### Loading and Unloading Stacks

Referring to FIGS. 1a-m, 6, 7a-d, 8 and 9, two stacks of bales 60a, 60b may be loaded with an empty vehicle-mounted double stack loading and unloading system 1 as follows.

Initially the front deck 30 is in the front-most position, the tines 44b of first clamping mechanism's tines 44b actuated in a substantially vertical position, and the second clamping mechanism 46 connected to the front deck 30 (FIG. 1a). The first clamping means 44 actuates the tines 44b in a substantially horizontal position upward and substantially above the top of the retaining forks 42b of the front deck 30, thereby allowing the deck 30 and second clamping means 46 to slide to the rear-most position (FIG. 1b). Sliding means (not shown) slide the front deck 30 and second clamping means 46 to the rear-most position (FIG. 1c). Once the front deck 30 is in the rear-most position the second clamping mechanism 46 disconnects from the front deck 30 and both decks 20, 30 are actuated to a vertical position while the second clamping mechanism 46 remains in place (FIG. 1d).

Once the rear end of the decks 20b, 30b and the co-operating retaining forks 42a, 42b substantially abut the ground, the vehicle 10 is moved backward so as to slide the forks 42a, 42b under a stack 60a (FIG. 1e). The first clamping mechanism 44 is actuated so as to engage the stack 60a with its tines 44b, thereby clamping the stack 60 securely in place (FIG. 1f). The decks 20, 30 are pivoted back to a substantially horizontal position (FIG. 1g), the first clamping mechanism's tines 44b are actuated in a substantially vertical position, and the second clamping mechanism 46 is once again connected to the front deck 30 and now engages the stack 60a so as to keep it securely placed on the front deck 30 (FIG. 1h). Preferably, the second clamping mechanism 46 engages the stack 60a just prior to the first clamping mechanism 44 disengaging from the stack 60a, so as to provide a continuous clamping action (FIG. 6).

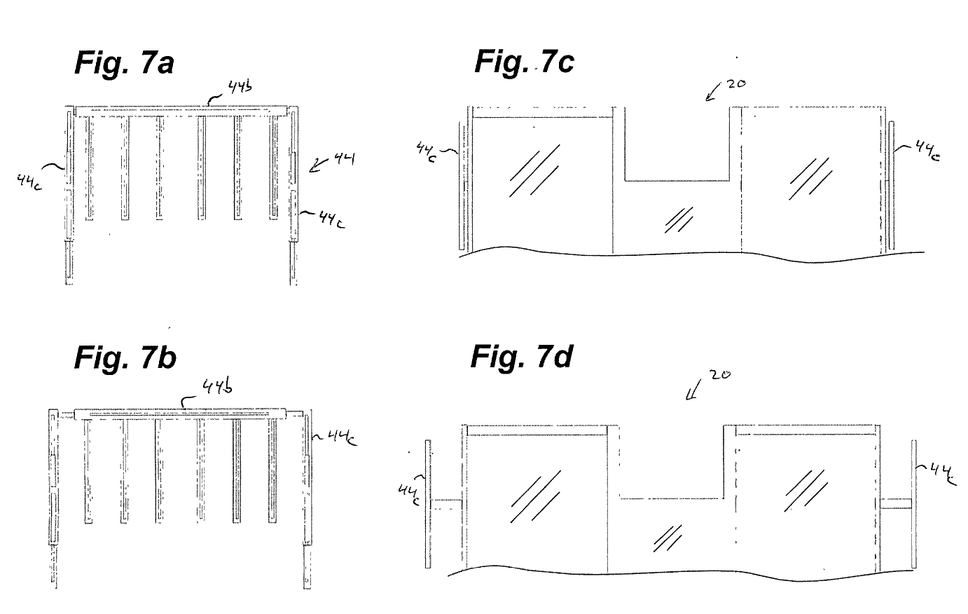

Next, sliding means such as a chain drive(not shown) slide the front deck 30, the second clamping mechanism 46 and the stack 60a to the front-most position (FIG. 1i). The sliding means are preferably associated with the trolley 47 and second clamping mechanism 46 so as to avoid mechanical complication with the front deck 30 as it rotates. Preferably, the first clamping mechanism 44 is capable of a width-wise expansion (FIGS. 7b, d) so as to provide extra clearance for a stack to pass through, should any individual bales happen to stick out. Once the front deck 30 and stack 60a are at the front-most position, the first clamping mechanism 46 would return to the original narrow width (FIGS. 7a, c) so as to assist in complying with vehicle width regulations when transporting the stacks 60a, 60b.

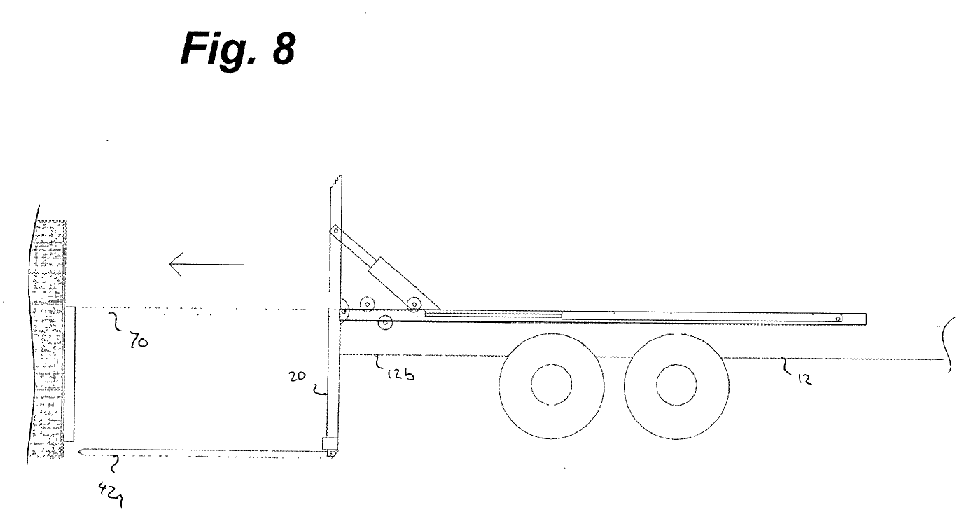

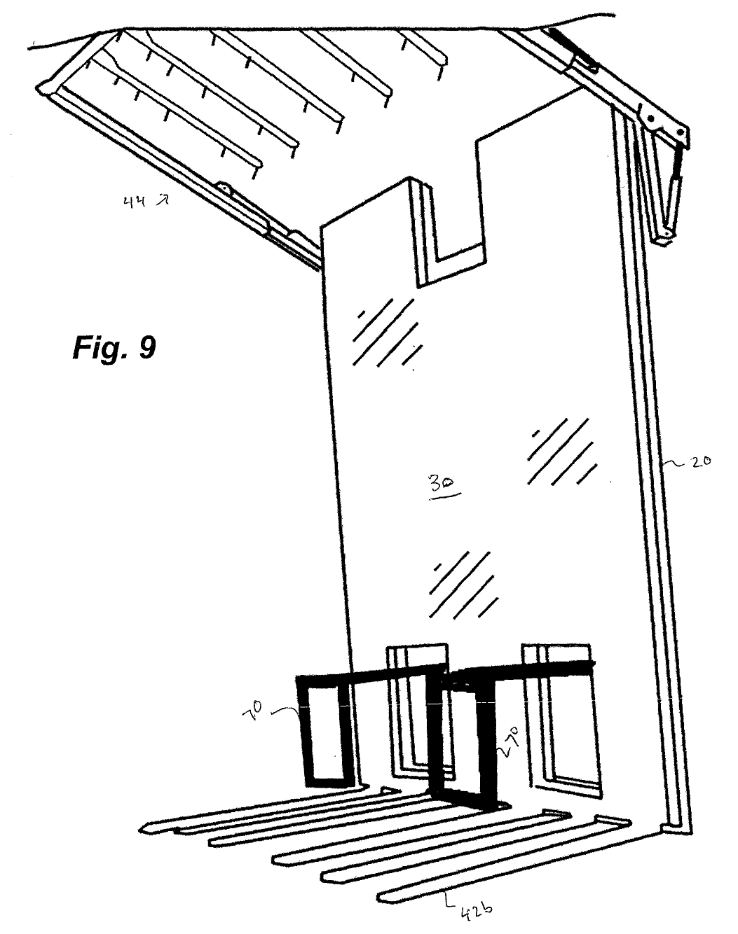

The rear deck 20 is again actuated to a vertical position (FIG. 1j), and when the rear end of the deck 20b, and the retaining forks 42a, substantially abut the ground, the vehicle 10 is moved backward so as to slide the forks 42a under another stack 60b (FIG. 1k). The first clamping mechanism 44 is actuated so as to engage the stack 60b with its tines 44b, thereby clamping the stack 60b securely in place, and the deck 20 is pivoted back to a substantially horizontal position (FIG. 1l). Two stacks 60a, 60b are now securely loaded onto the vehicle 10 (FIG. 1m). Unloading of the stacks 60a, 60b is accomplished by reversing the above sequence of steps. Preferably, to assist in unloading a stack from the retaining forks 42a, 42b when they substantially abut the ground, a push-off device 70 and actuating means (not shown) are provided (FIGS. 8-9). Push-off devices are well known to those of skill in the art.

In an alternate arrangement (not shown), two or more front decks can be employed to sequentially load multiple stacks. The next available or active front deck is selected in sequence from the two or more front decks and is moved rearwardly to overlie the rear deck for loading of a next available active stack. Once all the front decks are loaded, the rear deck is loaded in a similar manner as described above.

The embodiments of the invention in which an exclusive property or privilege is being claimed are defined as follows:

1. Apparatus for loading and unloading stacks between a transport vehicle and a ground surface, said vehicle including a support frame having a rear end, the apparatus comprising:
a rear deck being pivotally mounted to the rear end of the support frame such that said rear deck is rotatable between a substantially horizontal position and a substantially vertical position wherein a rear end of said rear deck abuts the ground;
a front deck movable along the support frame between a front-most and rear-most position such that when said front deck'is in the rear-most position said front deck overlies the rear deck for co-rotation therewith so that a front stack can be loaded and unloaded from said overlying front deck, and such that when the front deck is in the front-most position it overlies the support frame and said rear deck is rotatable without co-rotation of said front deck so that a rear stack can be loaded and unloaded from said rear deck;
means for rotating said rear deck between the horizontal position and the vertical position;
means for moving said front deck between said front-most and said rear-most positions; and
means associated with each of said rear and front decks for retaining a stack thereon.

2. The apparatus of claim 1 wherein the means for retaining a stack on said front deck or said rear deck comprise:
forks extending substantially perpendicular from a rear end of each of said front and rear decks and adapted for advancing under a stack when the front and rear decks are rotated to the vertical position;
clamping mechanisms mounted to said front and rear decks for assisting in loading and unloading said stack to and from said front and rear decks;
means for actuating the clamping mechanisms between a stack clamping position and an unclamped position.

3. The apparatus of claim 1 wherein the means for retaining a stack on said front deck or said rear deck comprise:
forks extending substantially perpendicular from a rear end of said rear deck and being adapted for advancing under a stack when the rear decks is rotated to the vertical position;
a rear clamping mechanism mounted to said rear deck for assisting in loading and unloading stacks to and from said rear deck and to and from said front deck when overlying the rear deck;
means for actuating the rear clamping mechanism between a stack clamping position and an unclamped position;
forks extending substantially perpendicular from a rear end of said front deck and being adapted for advancing under a stack when the front and rear decks are rotated to the vertical position;
a front clamping mechanism associated with said front deck for securing the first stack to said front deck; and
means for actuating the front clamping mechanism between a stack clamping position and an unclamped position;

4. The apparatus of claim 3 wherein the front clamping mechanism is mounted to a carriage movable along the frame and is separate from the front deck.

5. The apparatus of claim 3 wherein the rear clamping mechanism further comprises:
left and right uprights having pivot ends and pivotally positioned on the left and right sides of said rear deck adjacent its front end;
a rack of tines pivotally positioned between and at distal ends of the left and right uprights; and
means to rotate the rack of tines between a clamping position and a unclamped position.

6. The apparatus of claim 5 wherein the rear clamping mechanism further comprises:
means to variably space the left and right uprights so as to vary an overall width of the rear clamping mechanism.

7. A method of loading stacks onto a transport vehicle having a substantially horizontal frame supporting a front deck and a rear deck which are normally and substantially parallel to the frame in a shipping position, the rear deck pivotally mounted for rotation about a rear end of the frame, the front deck movable along the frame and the frame being of sufficient length to support the decks sequentially, the method comprising the steps of:
moving the front deck along the frame from a front-most shipping position to a rear-most pivoting position overlying the rear deck for co-rotation therewith;
co-rotating the front deck with the rear deck so that a first stack can be loaded on the front deck;
retaining the first stack onto the front deck;
co-rotating the front deck, and first stack thereon, with the rear deck to a horizontal position;
moving the front deck, and first stack thereon, along the frame from the rear-most pivoting position to the front-most shipping position;
rotating the rear deck so that a second stack can be loaded thereon;
retaining the second stack onto the rear deck;
rotating the rear deck, and second stack thereon, to a shipping position wherein the first and second stacks are loaded on the vehicle.

8. A method of loading two stacks onto a transport vehicle having a substantially horizontal frame supporting a front deck and a rear deck which are normally and substantially parallel to the frame in a shipping position, the rear deck pivotally mounted for rotation about a rear end of the frame, the front deck movable along the frame and the frame being of sufficient length to support the decks sequentially, the method comprising the steps of:
moving the front deck along the frame from a front-most shipping position to a rear-most pivoting position overlying the rear deck for co-rotation therewith, the front deck and the rear deck each having forks extending substantially perpendicularly therefrom;
rotating the rear deck and overlying front deck so that the front deck's forks are adjacent the ground in a loading position;
advancing the front deck forks under a first stack;
rotating the rear deck and overlying front deck so that the front deck and first stack are again substantially parallel to the frame;
moving the front deck along the frame from the rear-most pivoting position to the front-most shipping position;
rotating the rear deck so that the rear decks forks are adjacent the ground in a loading position;
advancing the rear deck forks under a second stack;
rotating the rear deck so that the rear deck and second stack are again substantially parallel to the frame wherein the first and second stacks are loaded on the vehicle.

9. The method of claim 8 further comprising the steps of:
clamping the first stack to the front deck before rotating the rear deck and overlying front deck to be substantially parallel to the frame; and
clamping the second stack to the rear deck before rotating the rear deck to be substantially parallel to the frame.

10. The method of claim 9 wherein the step of clamping the first stack to the front deck further comprises the steps of:
clamping the first stack to the front deck using a clamping mechanism associated with the rear deck before rotating the rear deck and overlying front deck to be substantially parallel to the frame;
clamping the first stack to the front deck using a clamping mechanism associated with the frame and movable therealong; and
releasing the rear deck clamping mechanism before moving both the frame's clamping mechanism and the front deck along the frame from the rear-most pivoting position to the front-most shipping position.

11. A method of loading multiple stacks using a transport vehicle having a substantially horizontal frame supporting multiple front decks and a rear deck which are normally and substantially parallel to the frame in a shipping position, the rear deck pivotally mounted for rotation about a rear end of the frame, the front decks movable along the frame and the frame being of sufficient length to support the decks sequentially, the method comprising the steps of:
sequentially loading all the front decks by:
(i) moving an active front deck along the frame so as to overlie the rear deck;
(ii) co-rotating the active front deck with the rear deck so that an active stack can be loaded;
(iii) retaining the active stack onto the active front deck;
(iv) co-rotating the active front deck, and active stack thereon, to a horizontal position;
(v) moving the active front deck, and active stack thereon, along the frame to a shipping position;
rotating the rear deck so that a final stack can be loaded thereon;
retaining the final stack onto the rear deck; and
rotating the rear deck, and final stack thereon, so that the rear deck and final stack are again substantially parallel to the frame wherein multiple stacks are loaded on the vehicle.
